(19) United States
(12) Patent Application Publication
(10) Pub. No.: US 2006/0218347 A1
(43) Pub. Date: Sep. 28, 2006

(54) Memory card

(76) Inventor: Takashi Oshima, Chiba-shi (JP)

Correspondence Address: C. IRVIN MCCLELLAND;OBLON, SPIVAK, MCCLELLAND, MAIER & NEUSTADT, P.C., 1940 DUKE STREET, ALEXANDRIA, VA, 22314, US

(21) Appl. No.: 11/205,125

(22) Filed: Aug. 17, 2005

(30) Foreign Application Priority Data
Mar. 25, 2005 (JP) 2005-089896

(51) Int. Cl. G06F 12/00

(52) U.S. Cl. 711/115; 711/103; 711/173; 711/118

(57) ABSTRACT

A memory card includes a first memory including first areas and second areas. A computing section gives an instruction to write writing data with an address assigned by a host unit into the first memory. A second memory stores an address unequal to an expected value. The address with the expected value is continuous with the address of the data last written. A first counter counts a number of requests to write the writing data of the address unequal to the expected value for each of the addresses. A third memory stores the address whose value in the first counter has reached a first set value. When receiving a request to write the writing data of the address stored in the third memory, the computing section gives an instruction to write the writing data into an unwritten part of the second areas, regardless of the address.

### CROSS-REFERENCE TO RELATED APPLICATIONS

This application is based upon and claims the benefit of priority from prior Japanese Patent Application No. 2005-089896, filed Mar. 25, 2005, the entire contents of which are incorporated herein by reference.

### BACKGROUND OF THE INVENTION

1. Field of the Invention

This invention relates to a memory card, and more particularly to a method of writing data into a memory card.

2. Description of the Related Art

In recent years, a memory card using nonvolatile semiconductor memory, such as flash memory, has been used as a recording medium for music data and image data. A file system manages the data stored in the memory card according to a write request made by an application or the like in the host unit using the memory card.

The file system divides the data to be written into clusters, assigns Logical Block Address (LBA) to each of the clusters, and allocates data to unwritten clusters in the order of LBAs. According to the allocation, the memory card actually writes data into memory. The clusters are classified into ones which store data and ones which store management data.

From the viewpoint of efficiency in reading data, the controller of the memory card allocates the data of LBAs succeeding one after another over a specific range (e.g., LBA0 to LBA15) as a management unit to a block.

What data is allocated to which cluster is written in a table (e.g., FAT (File Allocation Table)) in the management data storage part of the clusters. When a file is read, the information is traced to restore the original data. In addition, the management data further includes directory entry (DIR) such as file names or folder names, file sizes, attributes and update date time of files.

Because of the above characteristics, these management data (FAT and DIR in the above example) are updated periodically while data is being written.

On the other hand, a flash memory for a memory card is characterized in that 1) data is written in pages and that 2) data is erased in blocks, each being composed of a plurality of pages. Therefore, when the data in a page included in a block having written pages are updated, a process called “moving write” is carried out. In a moving write operation, the data to be written (new data) are written into a new block in which no data is written and the data remaining unchanged are copied from an old block including the old data (or the data to be replaced with new data) into a new block. Accordingly, it may take a considerable time to write one page.

As described above, the file system allocates the data in a succeeding specific number of LBAs (e.g., LBA0 to LBA15) to one block. As a result, each time the data in a discontinuous LBA are written, moving the block including the data of the LBA group to which the LBA belongs is needed. This decreases the writing speed.

Continuity of LBAs is disrupted when the management of data is updated. Since these are updated periodically, a moving write operation takes place periodically.

To avoid a moving write operation when the management data is updated, an additionally rewritable cache block (needing no moving write operation) is provided. In this case, however, the file system has to determine the data in which LBA should be written into the cache block (or are updated frequently). That is, on the logical format used in the memory card, what LBA the management data (FAT, DIR) belong to must be determined.

A method of making the determination may be to analyze the contents of the MBS (Master Boot Sector) storing specific management data and of the file management data. However, to make an analysis of these, extra time and resources, including the time to read these data, a buffer for storing the read-out data, and the time to analyze these, are required.

### BRIEF SUMMARY OF THE INVENTION

According to a first aspect of the present invention, there is provided a memory card comprising: a first memory including a plurality of first areas and a plurality of second areas, the first areas and the second areas being composed of a plurality of write unit areas; a computing section giving an instruction to write writing data with an address assigned by a host unit into the first memory; a second memory storing an address unequal to an expected value, the address with the expected value being continuous with the address of the data last written; a first counter counting, for each of the addresses, a number of requests to write the writing data of the address unequal to the expected value; and a third memory storing the address whose value in the first counter has reached a first set value, wherein the computing section, when receiving a request to write the writing data of the address stored in the third memory, gives an instruction to write the writing data into an unwritten part of the second areas, regardless of the address.

According to a second aspect of the present invention, there is provided a memory card comprising: a memory including a plurality of first areas and a plurality of second areas, the first areas and the second areas being composed of a plurality of write unit areas; and a computing section giving an instruction to write writing data with an address assigned by a host unit into the memory, wherein the computing section, when receiving a request to write the writing data of an address unequal to an expected value which is continuous with the address of the data last written, gives an instruction to write the writing data into an unwritten part of the second areas, regardless of the address.

### BRIEF DESCRIPTION OF THE SEVERAL VIEWS OF THE DRAWING

FIG. 1 is a perspective view schematically showing the configuration of the devices and others mounted on a memory card according to an embodiment of the present invention;

FIG. 2 is a block diagram showing a configuration including a host and a memory card;

FIG. 3 shows the difference in data arrangement between a flash memory assumed by the host and a flash memory actually used;

FIG. 4 shows a communication hierarchy of the host and that of the memory card;

FIGS. 5A and 5B show the formats of commands issued by the host;

FIG. 6 shows a block write operation assumed by the host and a write process actually carried out by the memory card in a comparative manner;

FIG. 7 shows a part of the memory space of the flash memory, a part of the RAM, and the counter in the memory card according to the embodiment;

FIG. 8 is a flowchart to help explain the write operation of the memory card according to the embodiment; and

FIGS. 9, 10, 11, 12, 13, 14, 15, 16, 17, 18, 19, 20, 21, 22, 23, 24, 25, 26, 27, 28, 29, 30, 31 and 32 each show one state of each section of the flash memory.

### DETAILED DESCRIPTION OF THE INVENTION

Hereinafter, referring to the accompanying drawings, an embodiment of the present invention will be explained. In the explanation below, component elements having almost the same function and configuration are indicated by the same reference numerals and a repeated explanation will be given only when necessary.

[1] Configuration

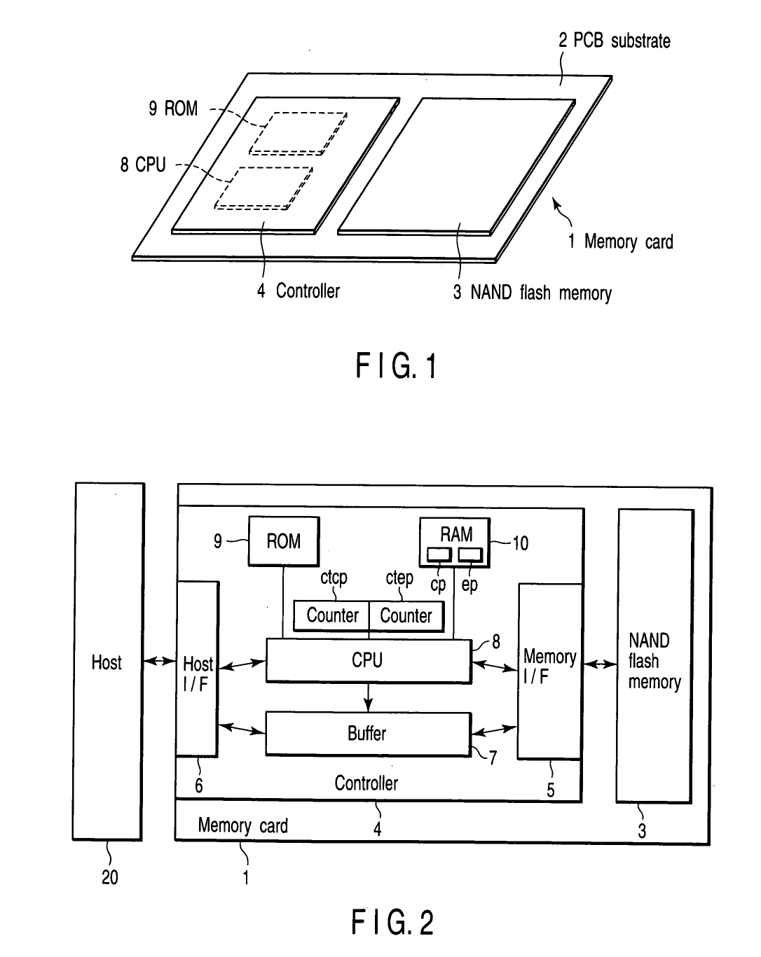

FIG. 1 is a perspective view schematically showing the configuration of the devices and others mounted on a memory card according to an embodiment of the present invention. As shown in FIG. 1, the memory card 1 of the embodiment comprises a PCB (Printed Circuit Board) substrate 2, a NAND flash memory (hereinafter, referred to as a flash memory) 3 provided on the substrate 2, and a controller 4.

On the controller 4, function blocks, including a CPU (Central Processing Unit) 8 and a ROM (Read-Only Memory) 9, are mounted. The details of each device will be described later. The flash memory 3 may be a binary memory which stores one bit of data into one memory cell or a multivalued memory which stores more than one bit of data (e.g., 2 bits of data) into one memory cell.

Although in FIG. 1, the flash memory 3 and controller 4 is arranged on the substrate 2, the flash memory 3 and controller 4 may be arranged on the same LSI (Large-scale Integration) substrate.

The terms “logical block address (LBA)” and “physical block address” used in the explanation below mean the logical address and physical address of a block itself, respectively. Moreover, while “logical address” and “physical address” mainly mean the logical address and physical address of a block itself, they may be addresses corresponding to units smaller than blocks.

The memory area of the flash memory includes ordinary blocks for usual data storage and cache blocks. How to allocate writing data to ordinary blocks and cache blocks will be explained in detail in item [1-2] Write Operation.

FIG. 2 is a block diagram showing a configuration including a host unit and a memory card. As shown in FIG. 2, the host unit (hereinafter, referred to as the host) 20 includes hardware and software (systems) for accessing a memory card connected thereto. The host 20 is configured to manage the physical state of the inside of the memory card 1 (i.e., what number logical sector address data is included in what physical block address or which block is erased) and to directly control the flash memory 3 in the memory card 1.

In addition, the host 20 allocates logical and physical addresses in units of 16 kB on the assumption that a flash memory 3 whose erase block size is set as 16 kB in an erase operation is used. In many cases, the host 20 write-accesses or read-accesses 16 kB of logical addresses sequentially (issues the corresponding commands).

When being connected to the host 20, the memory card 1 receives power and operates, thereby carrying out a process according to the access provided by the host 20.

The flash memory 3 is nonvolatile memory. The erase block size of the flash memory in an erase operation (the block size of an erase unit) is set as 256 kB. Data is written into or read from the flash memory 3 in units of, for example, 16 kB. The flash memory 3 is produced using, for example, 0.09-μ/m processing techniques. That is, the design rule for the flash memory 3 is less than 0.1 μm.

The controller 4 includes a memory interface section 5, a host interface section 6, a buffer 7, and a RAM (Random Access Memory) 10 in addition to the CPU 8 and ROM 9.

The memory interface section 5 provides an interface between the controller 4 and flash memory 3. The host interface section 6 provides an interface between the controller 4 and host 20.

The buffer 7 temporarily stores a specific amount of data (e.g., one page of data) when the data sent from the host 20 is written into the flash memory 3. In addition, the buffer 7 temporarily stores a specific amount of data when the data read from the flash memory 3 is sent to the host 20.

The CPU (computing section) 8 supervises the entire operation of the memory card 1. For example, when the memory card 1 receives power, the CPU 8 loads firmware (control program) stored in the ROM 9 into the RAM 10, thereby executing a specific process. According to the firmware, the CPU 8 creates various tables in the RAM 10, accesses the relevant area of the flash memory 3 according to a write command, a read command, or an erase command received from the host 20, or controls a data transfer process via the buffer 7.

The ROM 9 stores the control program and the like used by the CPU 8. The RAM 10, which is nonvolatile memory, is used as a work area of the CPU 8 and stores the control program and various tables.

The RAM 10 further has areas cp, ep (RAMcp, RAMep) for managing cache blocks explained later. Each of the RAMcp and RAMep has, for example, eight memory units. The RAMcp stores LBAs of candidates to be written into the cache blocks.

According to the state of the LBAs in the RAMcp and RAMep, a cp counter ctcp and an ep counter ctep do counting. A detailed operation of the RAMcp, RAMep, cp counter ctcp, and ep counter ctep will be explained in item [2] Write Operation.

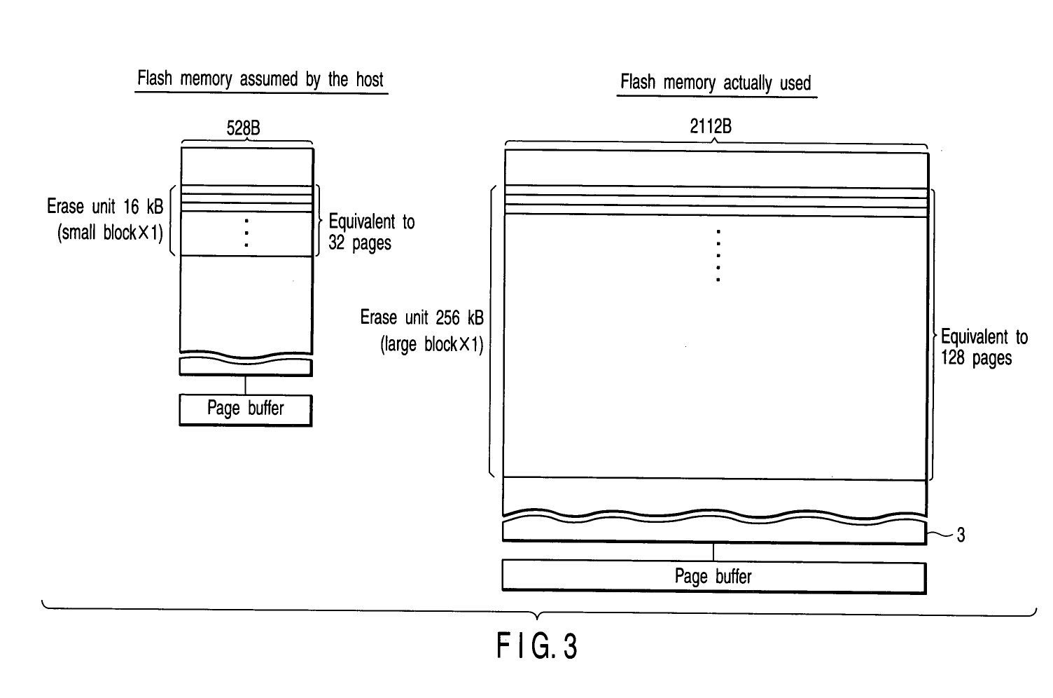

FIG. 3 shows the difference in data arrangement between a flash memory assumed by the host and a flash memory actually used (that is, the flash memory in the memory cards).

In the flash memory assumed by the host 20, each page contains 528 bytes (512-byte data storage part+16-byte redundancy part) and 32 pages constitute an erase unit (that is, 16 kB+0.5 kB (here, K is 1024)). Hereinafter, the erase unit is called a small block and a card installing such a flash memory may be referred to as a “small block card.”

On the other hand, in the flash memory 3 actually used, each page contains 2112 bytes (e.g., 512-byte data storage part×4+10-byte redundancy part×4+24-byte management data part) and 128 pages constitute an erase unit (that is, 256 kB+8 kB). Hereinafter, the erase unit is called a large block and a card installing such a flash memory 3 may be referred to as a “large block card.” In the explanation below, for the sake of convenience, the erase unit of the small block card assumed 16 kB and the erase unit of the large block card is assumed 256 kB.

Furthermore, each of the flash memory assumed by the host 20 and the flash memory 3 actually used has a page buffer for inputting and outputting data to and from the flash memory. The memory capacity of the page buffer provided in the flash memory assumed by the host 20 is 528 bytes (512 bytes+16 bytes). On the other hand, the memory capacity of the page buffer provided in the flash memory actually used is 2112 bytes (2048 bytes+64 bytes). In a data write operation or the like, each page buffer inputs or outputs data to or from the flash memory in units of one page corresponding to its memory capacity.

FIG. 3 shows a case where the erase block size of the flash memory 3 actually used is 16 times as large as the erase block size of the flash memory assumed by the host 20. The present invention is not limited to this. For instance, the flash memory 3 actually used may be configured so as to have another magnification, provided that the magnification is about an integral multiple.

To make the memory card 1 a practically useful product, it is desirable that the memory capacity of the flash memory 3 shown in FIG. 3 should be 1 GB or more. If the memory capacity of the flash memory 3 is, for example, 1 GB, the number of 256-kB blocks is 512.

In addition, although FIG. 3 shows the case where an erase unit is a 256-kB block, the flash memory 3 may be configured so that an erase unit is a 128-kB block, which will be practically useful. In this case, the number of 128-kB blocks is 1024.

Furthermore, while FIG. 3 shows the case where the erase block size of the flash memory 3 actually used is larger than the erase block size of the flash memory assumed by the host 20, the present invention is not limited to this. For instance, the erase block size of the flash memory 3 actually used may be smaller than the erase block size of the flash memory assumed by the host 20.

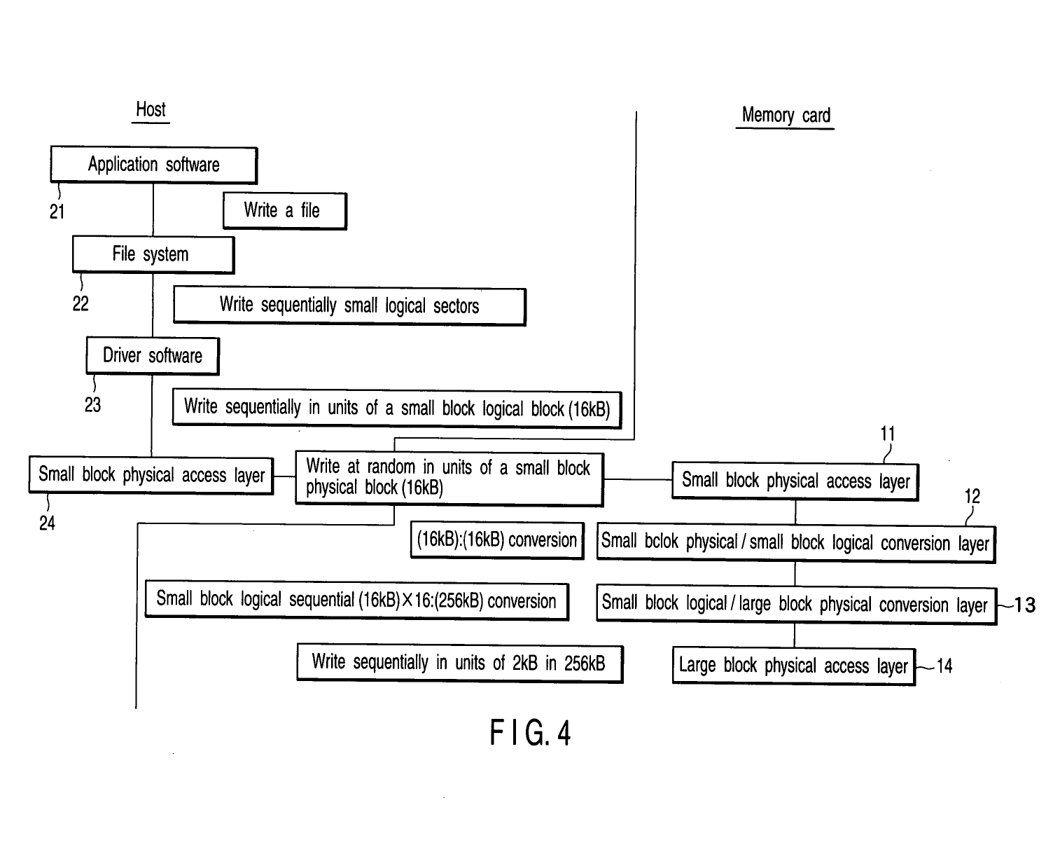

FIG. 4 shows a communication hierarchy of the host and memory card. As shown in FIG. 4, the system of the host 20 includes application software 21, a file system 22, driver software 23, and a small block physical access layer 24. On the other hand, the system of the memory card 1 includes a small block physical access layer 11, a small block physical address/small block logical address conversion layer 12, a small block logical address/large block physical address conversion layer 13, and a large block physical access layer 14.

For example, when the application software 21 on the host 20 requests the file system 22 to write a file, the file system 22 instructs the driver software 23 to write sectors sequentially on the basis of the small block logical addresses. In response to this, the driver software 23 operates so as to realize sequential writing in units of a 16-kB block on the basis of the small block logical addresses. Specifically, the driver software 23 performs logical block address/physical block address conversion, issues a random write command using small block physical block addresses via the small block physical access layer 24 to the memory card 1 and transfer data.

In both cases where small blocks are used and where large blocks are used, write access, in terms of protocol, is based on the assumption that information is transmitted and received in this order: (1) command, (2) page address (row address), (3) column address, (4) data, and (5) program acknowledge command.

The small block physical access layer 11 of the memory card 1, when receiving a write command using small block physical addresses from the host 20, acquires not only small block physical addresses and actual data but also the small block logical addresses included in the auxiliary data attached to the actual data.

The small block physical address/small block logical address conversion layer 12 has a first table. The first table is used to convert small block physical addresses (corresponding to a 16-kB block) into small block logical addresses (corresponding to a 16-kB block) in reading data.

When the small block physical access layer 11 receives a write command and acquires a small block logical address, the conversion layer 12 reflects this in the first table. It also reflects a small physical block address in the first table.

The small block logical address/large block physical address conversion layer 13 has a second table. The second table is used to convert small block logical addresses (corresponding to sequential 16 units of a 16-kB block) into a large block physical address (corresponding to a 256-kB physical block) in reading data.

When the small block physical access layer 11 receives a write command and acquires a small block logical address, the conversion layer 12 reflects this in the second table.

The large block physical access layer 14 determines the data arrangement in the flash memory 3 on the basis of the small block logical address acquired by the small block physical access layer 11 in response to a write command, and writes 16 kB of data sequentially in units of 2 kB (one page) into a 256-kB physical block (large physical block). As a result of one small block (16 kB) of data being written, data is written into 8 pages (1 page=2 kB) of the large physical block. The host allocates one LBA to one small logical block.

Furthermore, the large block physical access layer 14 stores the acquired small block logical address and small physical block address into a specific area of the management data area in the flash memory 3.

As described above, since the host 20 issues a command on the basis of a small block physical address, the memory card 1 manages data so as to be capable of finding which large physical block has the data corresponding to the small block physical address. Specifically, the memory card 1 not only manages the correspondence between a small block logical address and a small block physical address for each 16-kB block but also manages data so as to be capable of finding which large physical block stores the data corresponding to the small logical block addresses of 256 kB of consecutive small blocks.

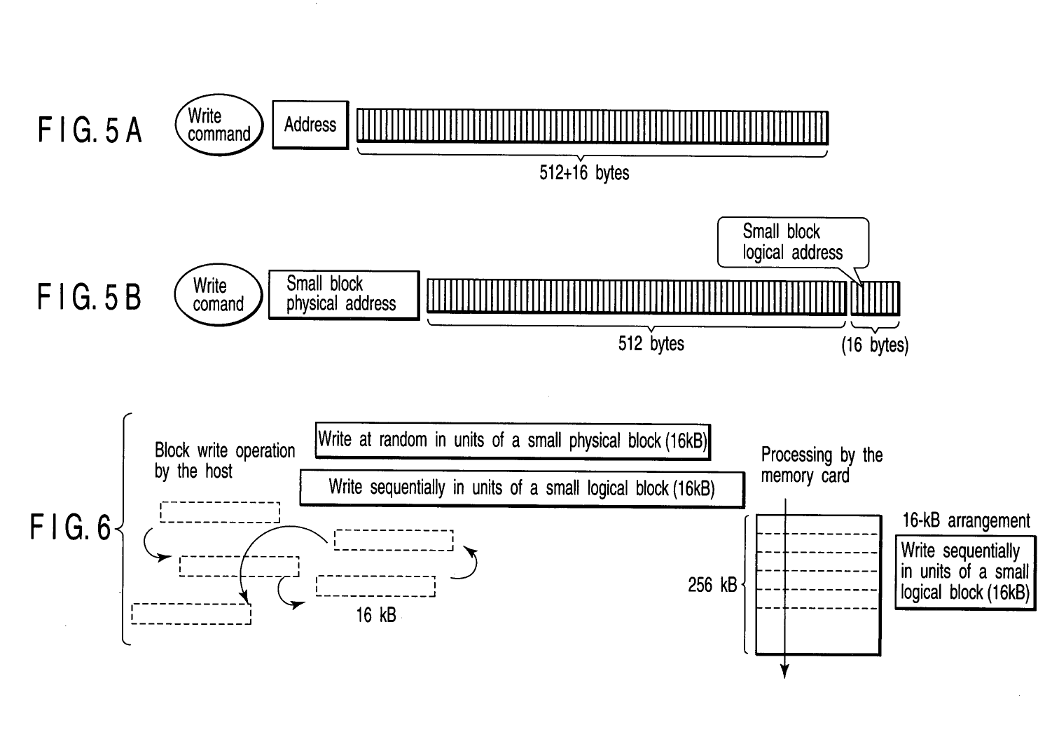

FIGS. 5A and 5B show formats of commands issued by the host 20. As shown in FIG. 5A, a packet of a command issued by the host 20 includes various pieces of information, including command type information (here, write), address (physical block address), and data (actual data such as contents and auxiliary data (512 bytes+16 bytes)).

As shown in FIG. 5B, “address” means a small block physical address to the memory card 1. In a packet with such a format, the 16-byte auxiliary data has a small block logical address (a logical address corresponding to a 16-kB block to be accessed) in a specific position. The memory card 1 acquires not only the command type information, small physical block address, and data but also particularly the small logical block address. The small logical block address is not added in a read command.

FIG. 6 shows a block write operation assumed by the host 20 and a write process actually carried out by the memory card 1 in a comparative manner. As shown in FIG. 6, when the operation of writing data sequentially in units of a 16-kB block on the basis of small block logical addresses takes place, the host writes data at random in units of a 16-kB block on the basis of small block physical addresses.

On the other hand, when the memory card 1 (at right in FIG. 1) receives a write command from the host 20, it writes data in units of a 16-kB block (small block) into the flash memory 3 on the basis of small-block logical addresses.

[2] Write Operation

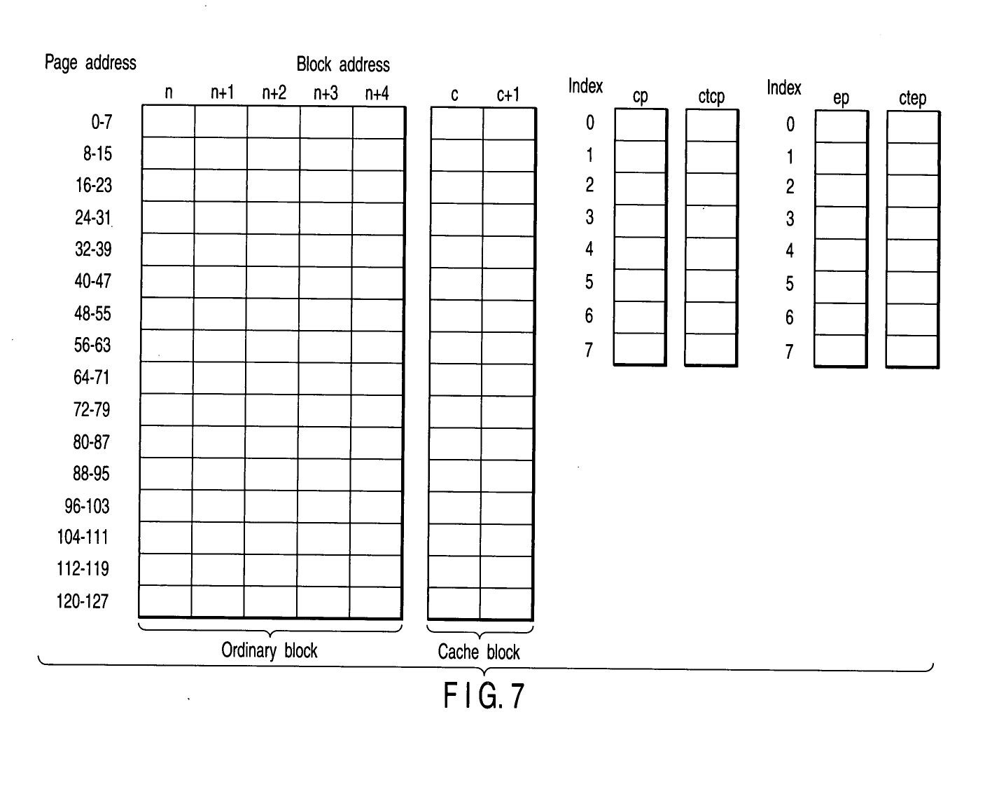

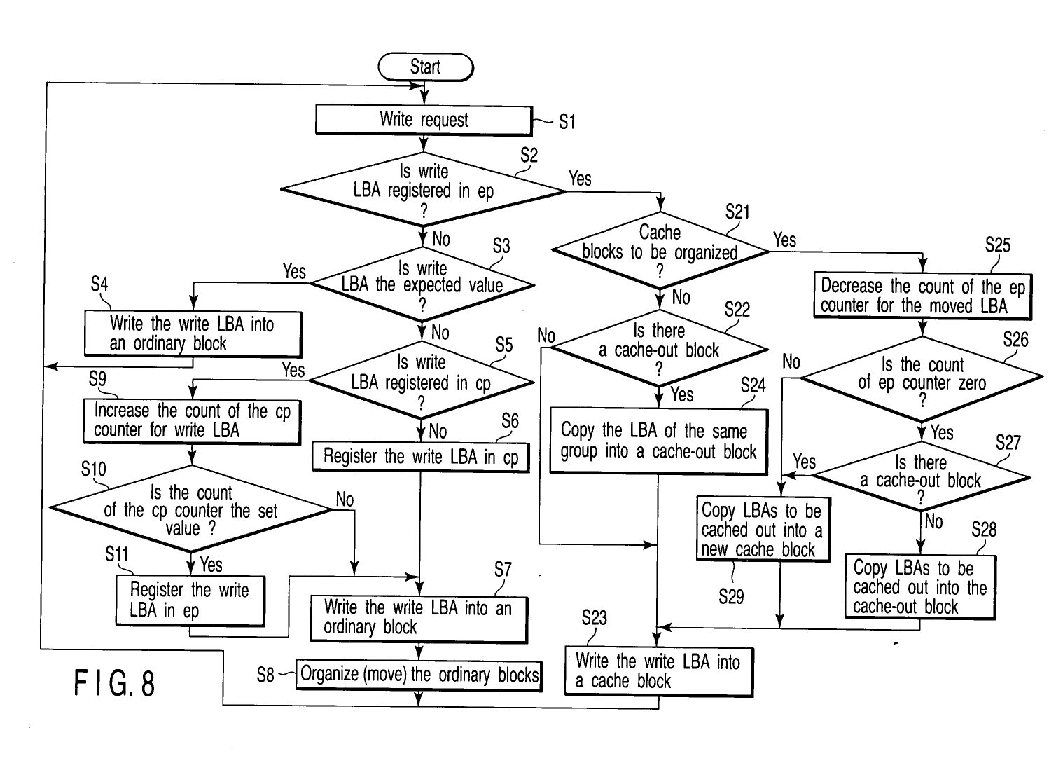

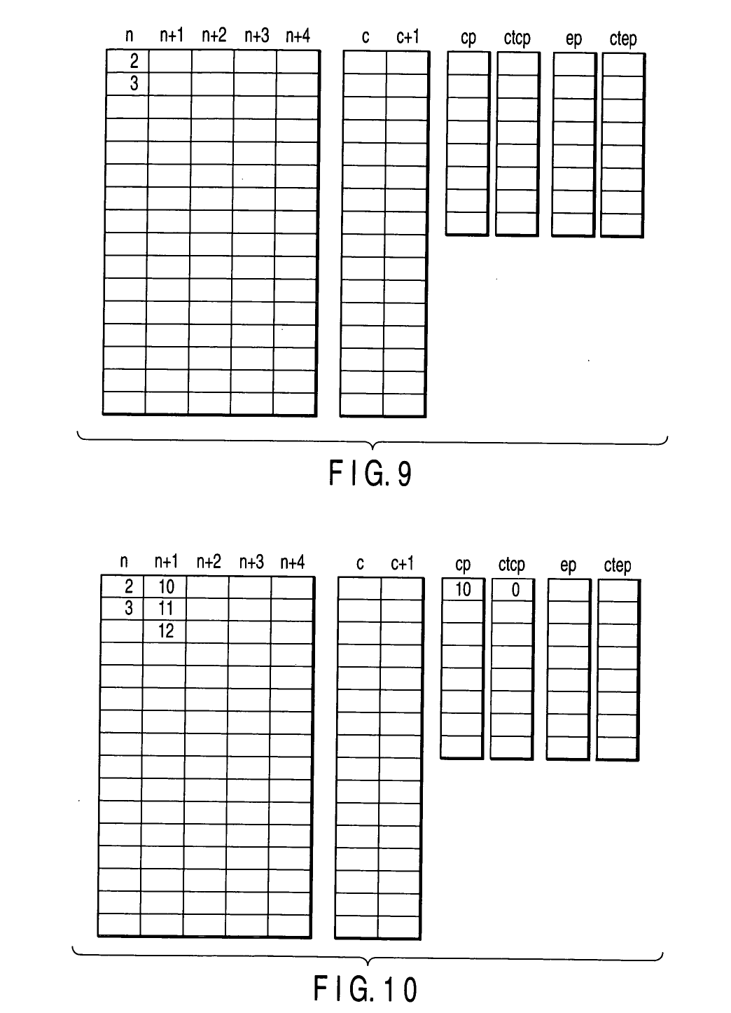

Next, referring to FIGS. 7 to 32, a write operation of the host configured as described above will be explained. FIG. 7 shows a part of the memory space of the flash memory, RAMcp, RAMep, and counters ctcp and ctep in the memory card according to the embodiment. FIG. 8 is a flowchart to help explain the write operation of the memory card according to the embodiment. FIGS. 9 to 32 each show a state of each of a part of the memory space of the flash memory, RAMs, and counters.

As shown in FIG. 7, the memory space includes ordinary data blocks (ordinary blocks) n to n+4 and cache blocks c, c+1. One column of each of blocks n to n+4, c, c+1 corresponds to a large block (that is, an erase unit). Addresses n to n+4, c, c+1 are allocated to the individual large blocks, respectively. Each large block is composed of 128 pages as described above.

Moreover, as described above, writing data from the host 20 into a small block corresponds to writing data into 8 pages of a large block. Therefore, each large block is divided in units of 8 pages. For example, the page addresses in the top write area of each large block are 0 to 7. Other write area follows the similar rule.

An area composed of 8 pages in one large block is referred to as a write area (corresponding to one square in the figure). Each write area is represented in coordinate form (x, y). For example, a write area in the eighth row in block address n is represented as (n, 8) write area.

To make reading easy, 16 small blocks whose small block logical addresses (hereinafter, referred to as LBAs) are consecutive are written into one large block (hereinafter, simply referred to as a block). In the embodiment, the number 16 corresponds to the fact that one block has 16 write areas. Therefore, for example, when the data of LBA2, LBA16 are written consecutively into a write area in a block, even if there is an empty (unwritten) write area in the block into which the data of LBA2 is written, the data of LBA16 are written into a write area in another block. Hereafter, 16 consecutive LBAs which should belong to the same block are called a group.

The data are copied in ordinary blocks to bring the data of LBAs belonging to the same group together into one block. On the other hand, the cache block is an additionally rewritable block.

Each of RAMcp and RAMep is composed of 8 memory units (one square in the figure). Each memory unit stores a LBA number. The RAMcp and RAMep may have more or less memory units. For the sake of explanation, indexes 0 to 7 are allocated sequentially to the individual memory units in each of RAMcp and RAMep along the column.

Referring to the numbers stored in RAMcp and RAM ep, the controller 4 allocates the data in a specific LBA to a cache block. When a certain LBA is registered in RAMcp, the LBA is not to be written into the cache block. On the other hand, RAMep stores LBA for a candidate to be written into the cache block. When data whose LBA is registered in RAMep is updated, the data of the LBA are written into the cache block, not into an ordinary block.

The cp counter ctcp is provided for each memory unit of RAMcp. The count of the cp counter increases according to an operation described later. Similarly, ep counter ctep is provided for each memory unit of RAMep. The count of the ep counter decreases from a set value according to an operation described later.

Next, a write operation will be explained, referring to FIGS. 8 to 31.

[2-1] Write Request

As shown in FIG. 8, when receiving a request to write the data of a certain LBA from the host 20 (step S1), the controller 4 determines whether the LBA to be written (hereinafter, referred to as the write LBA) is registered in RAMep (step S2).

Next, the controller 4 determines whether the LBA is an expected value (step S3). In the embodiment, the “expected value” means that the LBA is continuous with the LBA of the last written data. If the LBA is discontinuous with the latter, the data to be written may be irrelevant to the previously written data, or the two data may not constitute a file. That is, the data of the LBA discontinuous with the LBA of the previously written data may be file information, such as FAT or DIR. Therefore, the continuity of LBAs is used as part of information for making the decision to write the data of the LBA into a cache block.

However, the present invention is not limited to this embodiment. The embodiment can be applied to most cases where, in a memory and its controller, the controller writes data according to a certain rule. A request to write data against the rule (or deviating from the expected value) is used as information for making the decision to write the data in a cache block. Therefore, depending on the configuration of the memory and its controller, a decision can be made using, for example, physical block addresses.

[2-2] Operation when the Write LBA is the Expected Value

When the write LBA is the expected value, the data of the write LBA is written into an ordinary block which is the same as the preceding LBA (step S4).

Next, the operation up to now will be explained using an example (FIG. 9). FIG. 9 shows a case where the data of LBA2 is written in write area (n, 1) and a request to write the data of LBA3 arrives. LBA3 has not been registered in RAMep and is continuous with LBA2 just written. Thus, as shown in FIG. 9, the data of LBA3 are written into write area (n, 2).

[2-3] Operation when the Write LBA is not the Expected Value

If in step S3 of FIG. 8, the write LBA is not the expected value, the controller 4 determines whether the write LBA is registered in RAMcp (step S5). If it has not been registered, the write LBA is registered in RAMcp and the cp counter ctcp making a count of the write LBA is set to “0” (step S6). Next, the controller 4 writes the data in the write LBA into an ordinary block (step S7). At this time, the data in the write LBA are written into a block differing from the one into which the data of the LBA just written are written.

Next, ordinary blocks are put in order (step S8). When the data of LBAs which should be in the same block (LBAs of the same group) spread in some blocks, the data are put together into one block.

Next, the operation up to now will be explained using examples (FIGS. 10 to 15). FIG. 10, which follows FIG. 9, shows a case where a request to write the data of LBA10, LBA11, LBA12 arrives in the state of FIG. 9. LBA10 is not the expected value from LBA3 just written and has not been registered in RAMcp. Thus, as shown in FIG. 10, LBA10 is registered in RAMcp and the cp counter ctcp for LBA10 is set to “0.”

Next, the data of LBA10 is written into write area (n+1, 1) in block n+1 different from the block in which the data of LBA3 just written exist. As described above, each time an instruction to write the data of LBA of expected value is given, a new block is consumed.

Next, since the LBA value of each of LBA11 and LBA12 is the expected value from LBA10, the writing of LBA11 and LBA12 is done in the same manner as in step S1 to step S4 (FIG. 9). As a result, the data of LBA11 and LBA12 are written into write areas (n+1, 2), (n+1, 3), respectively.

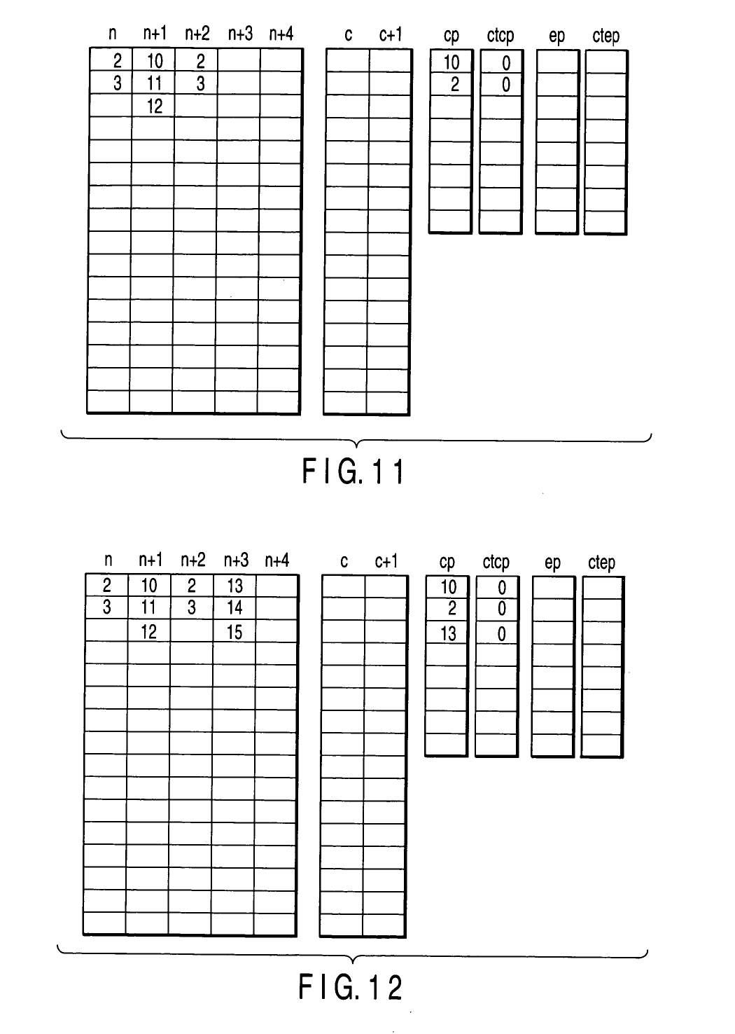

FIG. 11, which follows FIG. 10, shows a case where a request to write the data of LBA2, LBA3 arrives in the state of FIG. 10. LBA2 is not the expected value from LBA12 and has not been registered in RAMcp. Thus, as shown in FIG. 11, LBA2 is registered in RAMcp and the cp counter ctcp for LBA10 is set to “0.” Then, the data of LBA2 are written into a new block different from the block in which the data of LBA12 just written exist, that is, for example, write area (n+2, 1) in block address n+2. Next, since LBA3 is the expected value from LBA2, the data is written into write area (n+2, 2) next to the write area in which the data of LBA2 is written.

FIG. 12, which follows FIG. 11, shows a case where a request to write the data of LBA13, LBA14, LBA15 arrives in the state of FIG. 11. LBA13 is not the expected value from LBA3 and has not been registered in RAMcp. Thus, as shown in FIG. 12, LBA13 is registered in RAMcp and the cp counter ctcp for LBA13 is set to “0.”

Then, the data of LBA13 are written into a new block differing from the block in which the data of LBA3 just written exist, that is, for example, write area (n+3, 1) in block address n+3. Next, since LBA14 and LBA15 are the expected values from LBA13, the data are written sequentially into write areas (n+3, 2), (n+3, 3) following the write area in which the data of LBA13 are written.

The data of LBA2 and LBA3 are written into two blocks. Therefore, when LBA13, LBA14, LBA15 are written into, these data are brought together into one block. Specifically, the data in the block in which the old data of LBA2 and LBA3 are written (hereinafter, referred to the old assign block) are moved to a block in which the latest data of LBA2 and LBA3 are written (hereinafter, referred to as a new assign block).

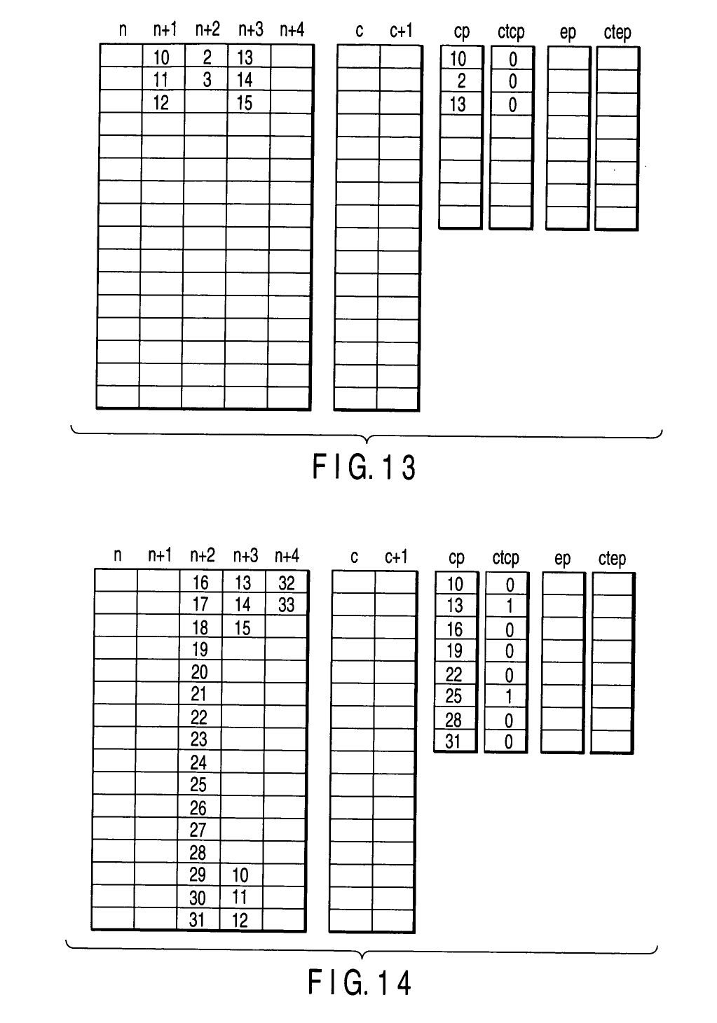

FIG. 13 shows a state following that of FIG. 12. In this example, since there is no other data belonging to the same groups as LBA2, LBA3, the data need not be put together into one group and only block n is just erased. Thereafter, block n functions as a clean block (erased block) when the data of a certain LBA are written. As described above, each time the data of LBA unequal to the expected value are written, a new assign block is created and the data excluding the data of the LBA to be written are copied from the old assign block into a new assign block, thereby erasing the old assign block.

When there is no available space in RAMcp, the oldest one of the registered LBAs (the LBA stored in index 0) is deleted.

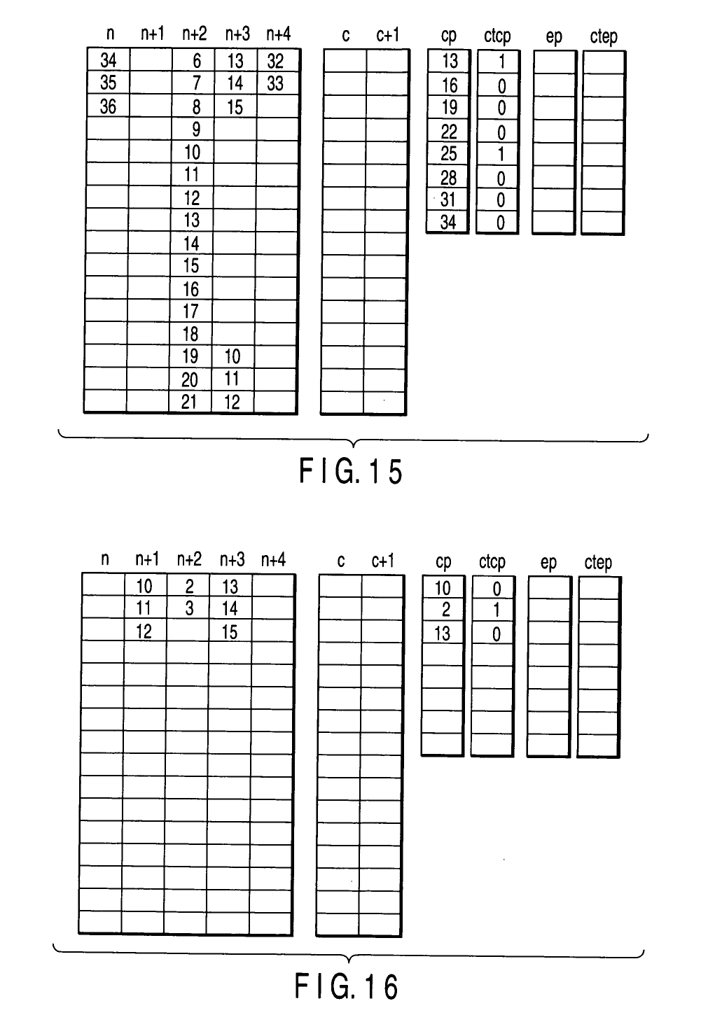

FIG. 14 shows a case where RAMcp has no available space and LBA34, LBA35, LBA36 discontinuous with LBA31 of the data just written are written into. In this case, as shown in FIG. 15, LBA10 in index 0 is deleted. Next, LBA in each of index 1 to index 7 is moved to the preceding index. As a result, LBA34 is registered in index 7 which is now empty. Then, the data of LBA34, LBA35, LBA36 are written into the empty blocks sequentially. It is desirable that the size of RAMcp should be set so as to always have a vacancy, taking into account the number of LBAs expected to deviate from the expected value.

[2-4] Operation when the Write LBA is Registered in cp

Next, if in step S5 of FIG. 8, the determination is true, the controller 4 increases the value of the cp counter ctcp for the write LBA (step S9). Next, the controller 4 determines whether the increased value of the cp counter ctcp has reached a set value (step S10). If it has not reached the set value, the process goes to step S7. Then, step S8 is carried out, if necessary.

On the other hand, if the result of the determination in step S10 has shown that the cp counter ctcp for the write LBA has reached the set value, this means that the write LBA interrupts the continuity of LBAs frequently. Accordingly, there is a strong possibility that the data of the LBA is management data (e.g., FAT or DIR). Therefore, when the data of the LBA are written next time or later, the LBA is registered in RAMep to show that it should be written into a cache block (step S11). At the same time, the LBA is deleted from RAMcp.

Then, the data in the write LBA are written into an ordinary block (step S7). Thereafter, step S8 is carried out, if necessary.

Next, the operation up to now will be explained using examples (FIGS. 16 to 18). In the examples below, the set value of RAMcp that triggers the entry of LBAs into RAMep is set as 2. As shown in FIG. 16, suppose the value of cp counter ctcp for LBA2 registered in RAMcp is 1.

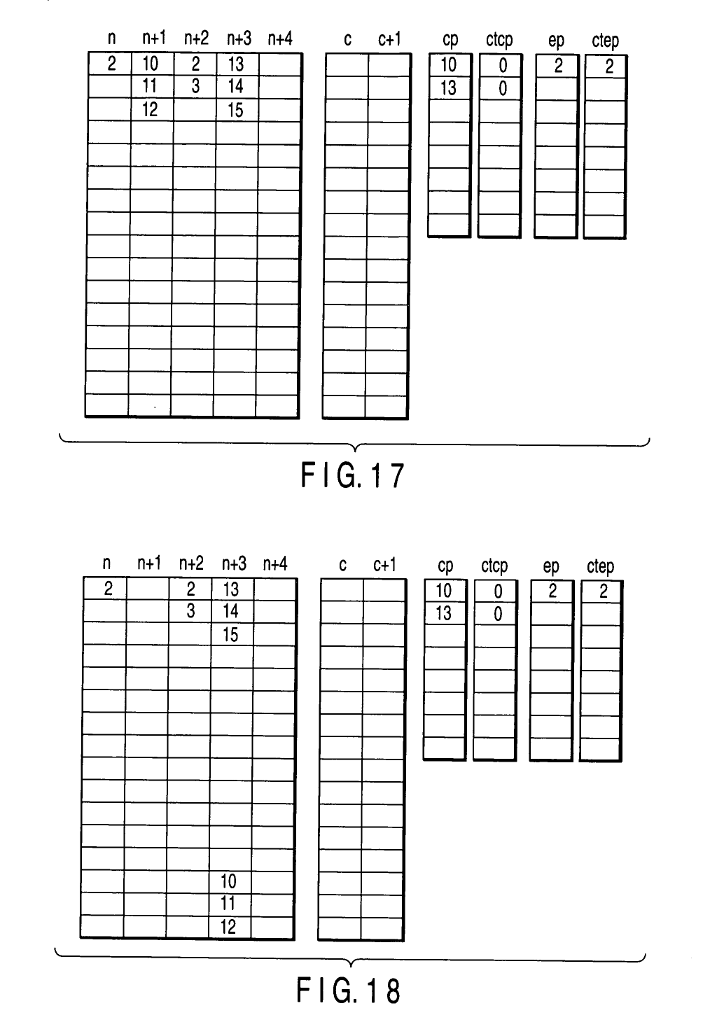

It is assumed that, in the state of FIG. 16, a request to write the data of LBA2 unequal to the expected value arrives. Then, as shown in FIG. 17, the value of the cp counter ctcp for LBA2 has increased to reach the set value. Next, LBA2 is registered in RAMep and then is deleted from RAMcp. Then, the data of LBA2 are written into block n.

When LBA2 is registered in RAMep, the ep counter ctep for LBA2 is set to an initial value. The initial value is set as, for example, 2. As described later, as a result of the organization of the cache blocks, each time the data of a certain LBA are moved to a new cache block, the value of the counter is decreased. In addition, each time the data of the LBAs registered in RAMep are written, the value of the counter is reset to the set value.

Next, as shown in FIG. 18, the data of LBA10 to LBA15 which belong to the same group and are written into a new assign block and an old assign block are organized.

[2-5] Operation with the Write LBA Registered in ep

If the result of the determination in step S1 of FIG. 8 has shown that the write LBA is registered in RAMep, the process proceeds to step S21. This means that the data of the write LBA should be written into a cache block. Then, with this timing, the cache blocks are organized, if necessary. Thus, the controller 4 determines whether to organize the cache blocks (step S21). For example, if the cache blocks are already filled up, the controller 4 decides on organizing the cache blocks.

[2-5-1] Operation when the Cache Blocks are not to be Organized

If the result of the determination in step S21 of FIG. 8 has shown that the cache blocks are not to be organized, cache-out blocks are organized, if necessary, using the present writing of the write LBA. Here, the cache-out blocks store the data of the LBAs expelled from the cache blocks because they fulfilled a condition explained later. The cache-out blocks will be explained later in detail.

First, the controller 4 determines whether a cache-out block exists (step S22). If no cache-out block exists, the write LBA is written into a write area next to the write area just written into in the cache block (step S23).

On the other hand, if the result of the determination in step S22 has shown that a cache-out block exists, the cache-out block is organized. Specifically, the cache-out block is used as a new assign block and the data of the LBAs belonging to the same group as the LBA in the cache-out block are copied from the old assign block (step S24). Then, the old assign block is deleted.

Thereafter, the process goes to step S23, where the data in the write LBA are written. Step S23 and step S24 may be carried out at the same time.

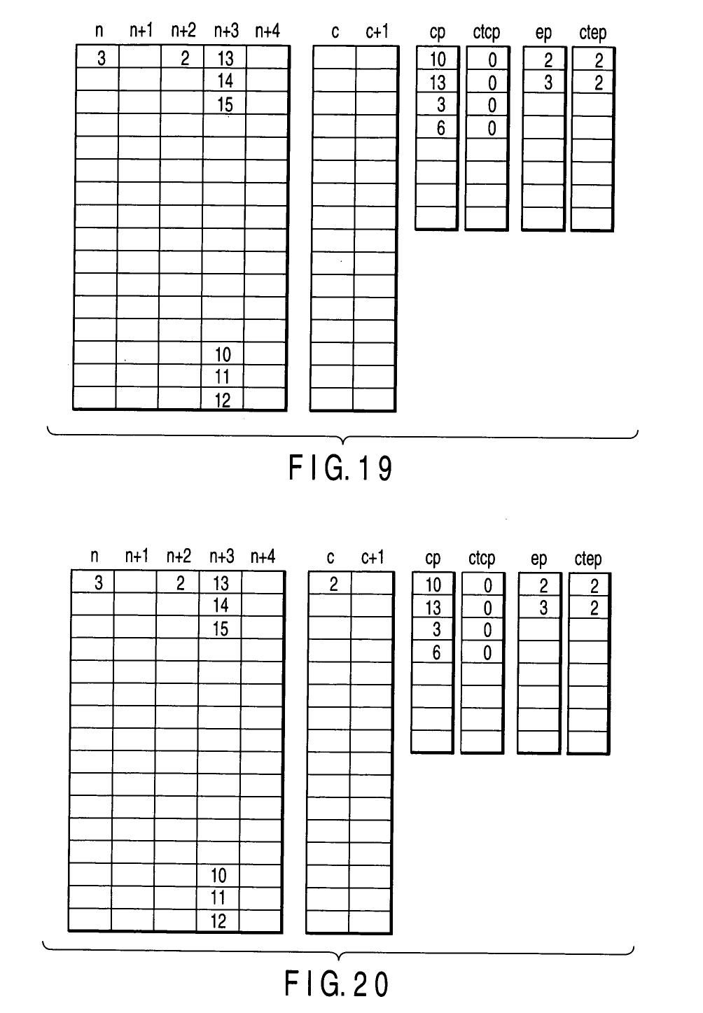

Next, explanation will be given using examples (FIGS. 19 to 22). FIG. 19 shows a case where the organization of the cache blocks is not needed and a request to write the data of LBA2 registered in RAMep arrives. In this case, as shown in FIG. 20, since LBA2 is registered in RAMep, the data of LBA2 are written into cache block c, not into an ordinary block.

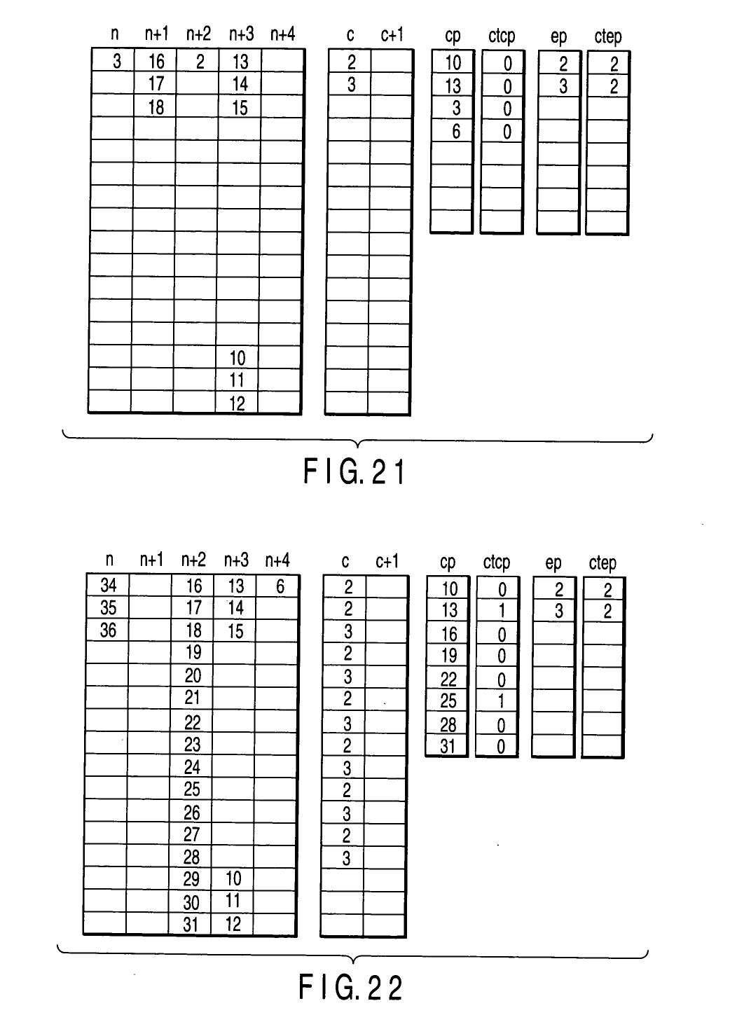

FIG. 21 shows a case where a request to write the data of LBA16 to LBA18 and LBA3 arrives in FIG. 20. As shown in FIG. 21, after the data of LBA16 to LBA18 are written into block n+1, LBA3 is registered in RAMep. Therefore, the data of LBA3 are written additionally into cache block c. Thereafter, the data to be written into the cache block are written into the area next to the write area just written into in the cache block, regardless of the number of LBA.

FIG. 22 shows a case where the organization of the cache blocks is not needed and there is a cache-out block n+4 for storing the data of LBA6 cached out. The data of LBA10 to LBA15 belonging to the same group as LBA6 are written into block (corresponding to the old assign block) n+3.

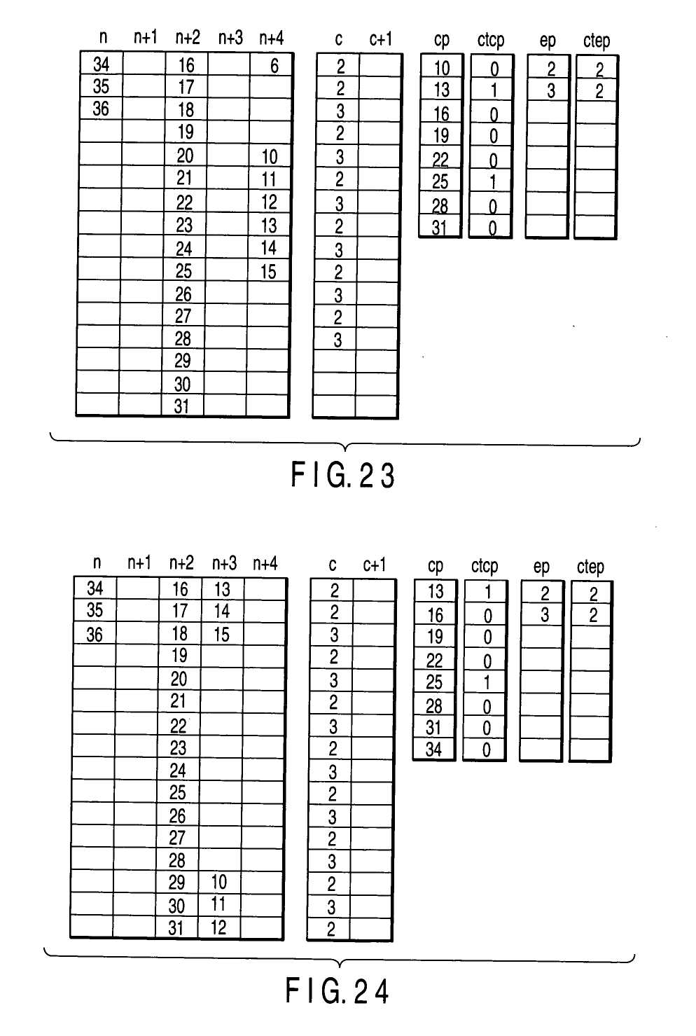

Therefore, as shown in FIG. 23, the data of LBA10 to LBA15 are copied into the write areas (n+4, 5) to (n+4, 10) of a new assign block n+4. Then, the old assign block n+3 is deleted.

[2-5-2] Operation when the Cache Blocks are to be Organized

If the result of the determination in step S21 of FIG. 8 has shown that the cache blocks are to be organized, the cache blocks are organized using the present writing of the write LBA. Specifically, the latest data in each LBA in the cache block are copied into the cache block (new assign cache block) last written into. At the same time, the ep counter ctep for the LBA whose data are moved is decreased (step S25). Therefore, the value of the ep counter for the LBA of the data which is written in the cache block and keeps being copied into a new assign cache block continues to decrease each time the data are copied.

Next, the controller 4 determines whether there is an LBA whose value of ep counter ctep has decreased to zero (step S26). The controller 4 does not write the data of the LBA whose value of ep counter ctep has reduced to zero into a new assign cache block and reserves it as a candidate to be cached out. That is, the data of the LBA is a candidate to be copied from the cache block into a new ordinary block (cache-out block).

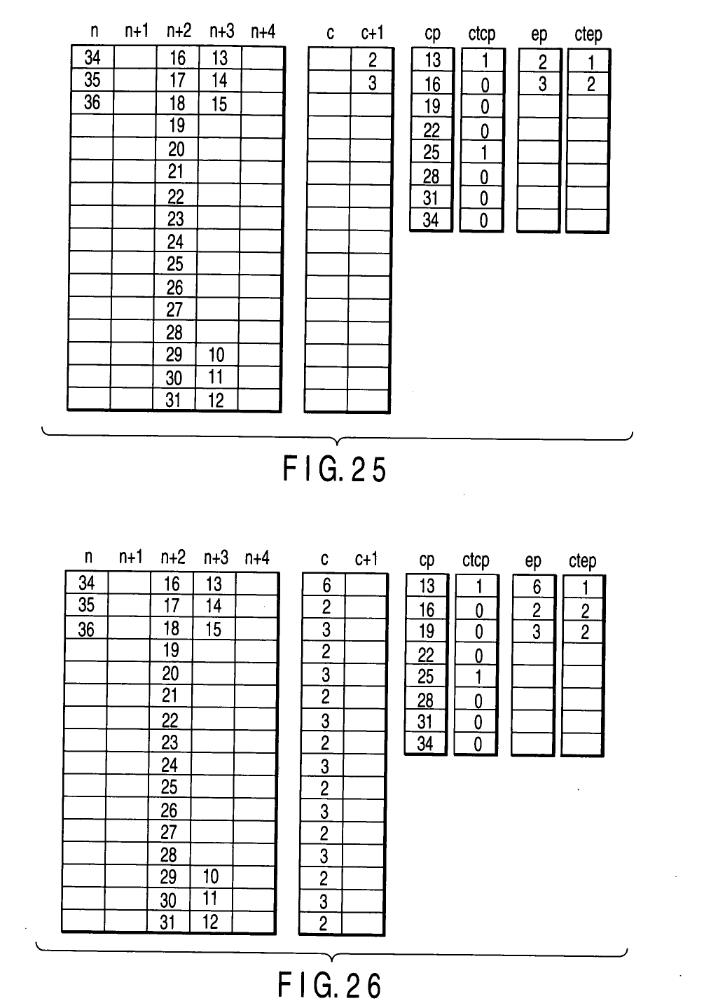

Next, a cache-out operation will be explained using examples (FIGS. 24 and 25). As shown in FIG. 24, cache block c has no empty write area. Suppose, in this state, a request to write the data of LBA3 arrives. Since cache block c cannot be written into, the cache blocks have to be organized.

Next, as shown in FIG. 25, the latest data (in this case, the data in write area (c, 15)) in an LBA (in this case, only LBA2) other than LBA3 requested to be written are copied from the old assign cache block c into cache block c+1. Here, the value of the ep counter ctep of LBA3 copied into the new assign cache block c+1 decreases but not becomes zero. Therefore, the data of LBA3 are not to be cached out.

Next, the old assign cache block c is deleted. Then, LBA3 is written into the new assign cache block c+1.

[2-5-2-1] Operation when No Cache-Out Block Exists

The controller 4 determines whether there is a cache-out block for storing the data in other LBAs already cached out (step S27). If no cache-out block is provided, the controller 4 prepares a new cache-out block and writes the data of the LBA to be cached out into the new cache-out block (step S28).

After the process in step S28, the cache block occupied by the old data (old assign cache block) is deleted. Thereafter, the data of the write LBA are written into the new assign cache block (step S23). At the same time that the data in the write LBA are written, the value of the ep counter ctep of the write LBA is set to an initial value. Step S28 and step S23 may be carried out at the same time.

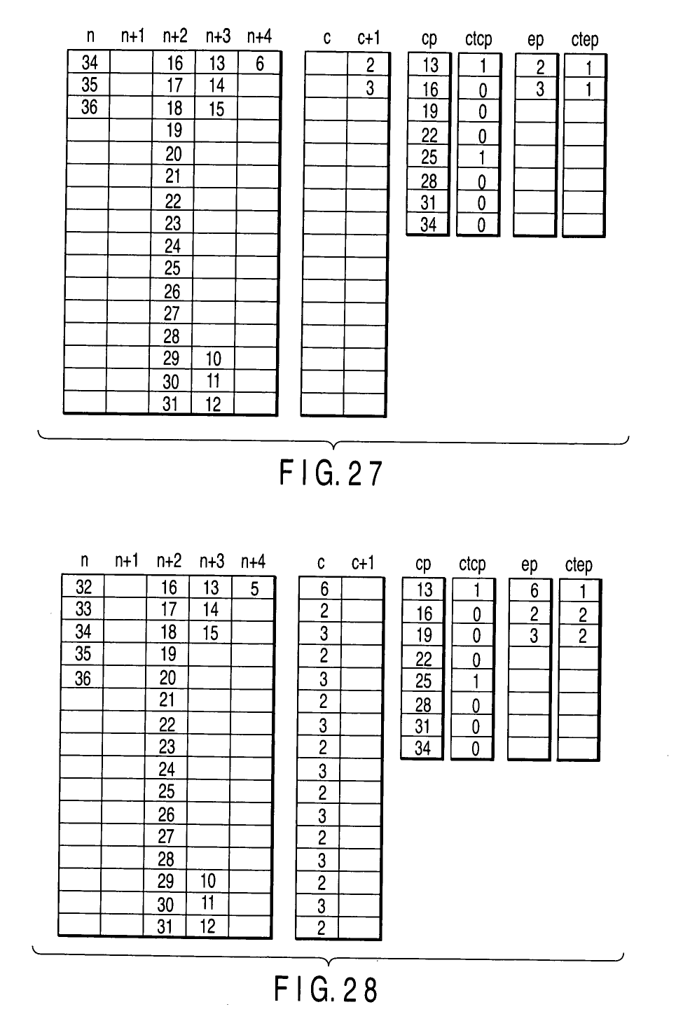

Next, the operation up to now will be explained using examples (FIGS. 26 and 27). As shown in FIG. 26, cache block c has no empty area. Suppose, in this state, a request to write the data of LBA3 arrives. Therefore, cache block c has to be organized. Here, the value of the ep counter of LBA6 is one.

In this case, as shown in FIG. 27, the latest data of LBA2 and LBA3 are copied from the old assign cache block c into a new assign cache block c+1. Here, when an attempt is made to copy LBA6 into cache block c+1, the value of the ep counter ctep of LBA6 becomes zero. Therefore, the data of LBA6 are set as a candidate to be cached out.

Then, since there is no cache-out block, block n+1 is set as a cache-out block and the data of LBA6 are written into block n+1. Then, cache block c is deleted. LBA6 is deleted from RAMep and the ep counter ctep of each of LBA2 and LBA3 is decreased.

[2-5-2-2] Operation when a Cache-Out Block Exists

If the result of the determination in step S27 has shown that a cache-out block already exists, the data of the LBA to be cached out are not cached out and copied into the new assign cache block (step S29). The reason for this is that the number of cache-out blocks is restricted to one because there is a limit to the size of the memory area.

It is possible to prepare an additional cache-out block and write the data of the LBA to be cached out into the additional cache-out block even if a cache-out block already exists as long as the capacity of the memory area permits it. Then, the process goes to step S23. Step S29 and step S23 may be carried out simultaneously.

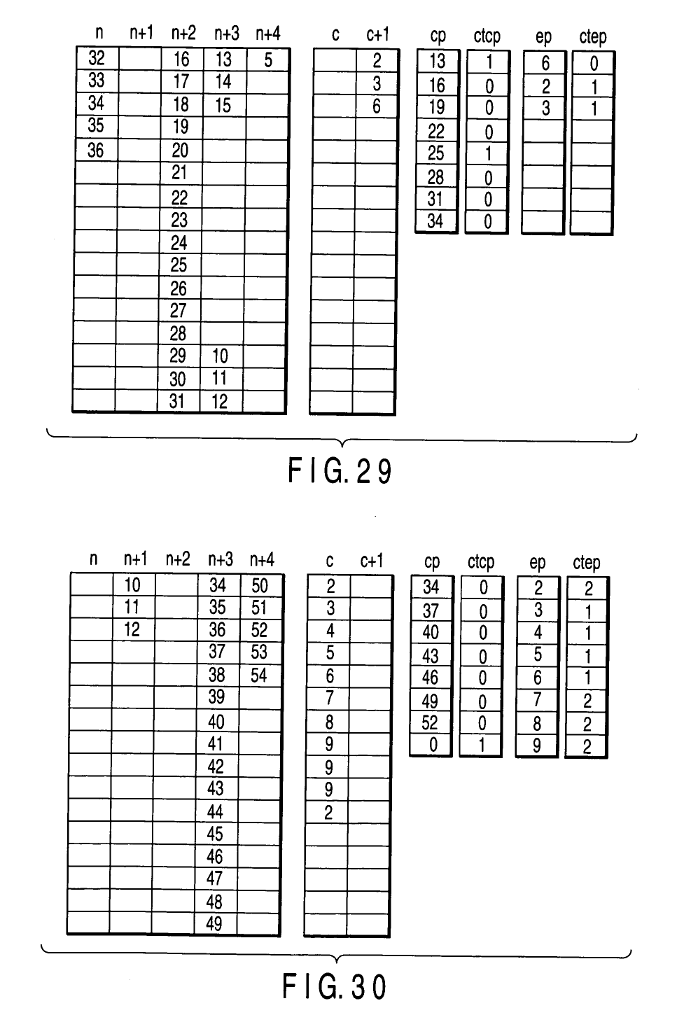

Next, the operation up to now will be explained using examples (FIGS. 28 to 32). Unlike FIG. 26, FIG. 28 shows a case where a cache-out block (block n+4) has already existed when an attempt is made to cache out LBA6. In this case, as shown in FIG. 29, the data of LBA6 are not cached out and are written into the new assign cache block c+1. Then, the old assign cache block is deleted. LBA6 will be cached out when the cache blocks are organized next time.

In the above explanation, the data of the LBAs which are written in the cache blocks and not further requested to be written are sorted by use of the ep counter ctep and then are written into ordinary blocks. In contrast, LBAs may be registered in RAMep in a first-in first-out manner. This will be explained using FIGS. 30 to 32.

FIG. 30 shows a case where RAMep has no available area and the value of the cp counter ctcp for LBA0 is one. Suppose, in this state, a request to write the data of LBA0 unregistered in RAMep arrives.

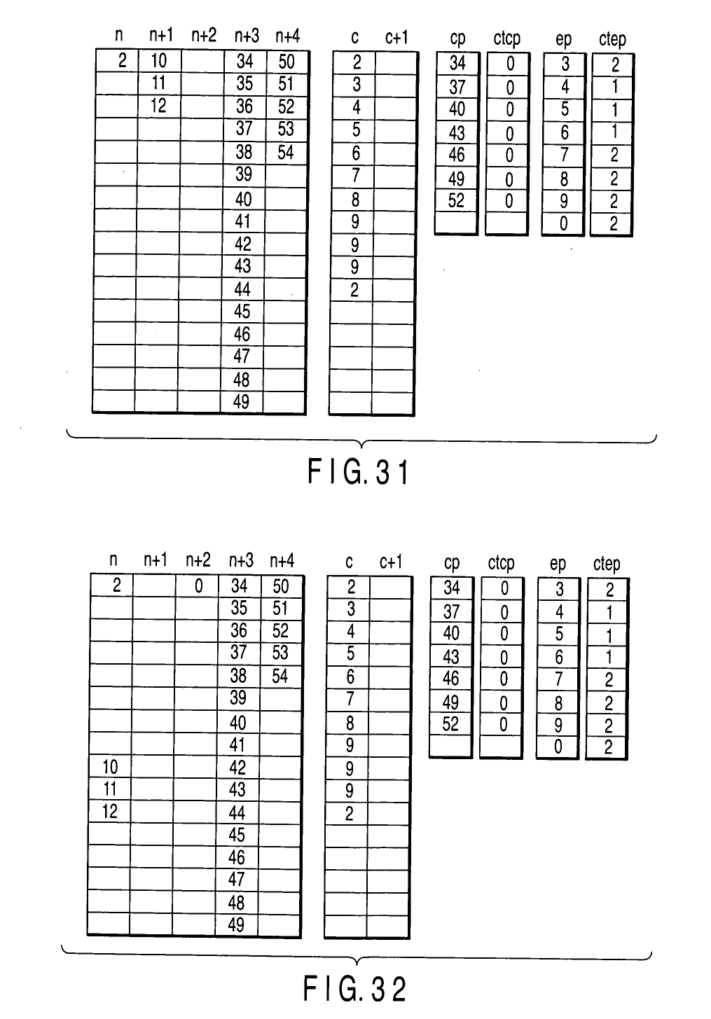

In this case, as shown in FIG. 31, the earliest registered LBA2 is removed from RAMep. Then, since the data of LBA2 is not the expected value from LBA12 just written, it is written into the erased block n. Then, the value of each of the indexes of RAMep is moved to a one smaller index one after another and LBA0 is registered in index 7 of RAMep. LBA0 is deleted from RAMcp.

Next, as shown in FIG. 32, the data of LBA10 to LBA12 are copied from the old assign block n+1 into a new assign block n and the old assign block n+1 is deleted. Then, the data of write LBA0 are written into block n+2.

With the memory card according to the embodiment, when a request to write the data of an LBA which is not the expected value from the LBA of the data just written arrives, the LBA is stored and the number of times when a request to write the data of unexpected LBA is counted. Then, the data of an LBA which is requested to be written with unexpected timing as many as a set value are written into an additionally rewritable cache block. Therefore, data triggering frequent data moving processes can be sorted out easily without analyzing their contents. As a result of a decrease in the number of data moving processes, a memory card realizing a high writing speed can be obtained.

Additional advantages and modifications will readily occur to those skilled in the art. Therefore, the invention in its broader aspects is not limited to the specific details and representative embodiments shown and described herein. Accordingly, various modifications may be made without departing from the spirit or scope of the general inventive concept as defined by the appended claims and their equivalents.

What is claimed is:

1. A memory card comprising:
a first memory including a plurality of first areas and a plurality of second areas, the first areas and the second areas being composed of a plurality of write unit areas;
a computing section giving an instruction to write writing data with an address assigned by a host unit into the first memory;
a second memory storing an address unequal to an expected value, the address with the expected value being continuous with the address of the data last written;
a first counter counting, for each of the addresses, a number of requests to write the writing data of the address unequal to the expected value; and
a third memory storing the address whose value in the first counter has reached a first set value,
wherein the computing section, when receiving a request to write the writing data of the address stored in the third memory, gives an instruction to write the writing data into an unwritten part of the second areas, regardless of the address.

2. The memory card according to claim 1, wherein the computing section gives an instruction to write the writing data of the address unequal to the expected value into an unwritten part of the first area.

3. The memory card according to claim 1, further comprising a second counter which sets a value for the address of the writing data to an initial value each time the writing data is written into the second area.

4. The memory card according to claim 3, wherein the computing section gives an instruction to copy a latest writing data of each of the addresses stored in one of the second areas into a new second area which is another one of the second areas, and
the second counter changes the value for the address of the writing data copied into the new second area.

5. The memory card according to claim 4, wherein the computing section copies the writing data of the address whose value in the second counter has reached a second set value into one of the first areas, and
after the writing data of the address whose value has reached the second set value is copied, the address of the writing data copied is deleted from the third memory.

6. The memory card according to claim 1, wherein the first areas and the second areas are data erase units of the first memory.

7. The memory card according to claim 6, wherein the first memory is a NAND flash memory.

8. The memory card according to claim 1, wherein a specific number of consecutive addresses form a group, and
the computing section, when the data of the addresses belonging to a same group are written in two of the first areas, gives an instruction to write the data written in an old first area, which is one of the two of the first areas, into a new first area, which is another one of the two of the first areas, and gives an instruction to erase the data in the old first area.

9. The memory card according to claim 8, wherein the computing section gives an instruction to additionally write the writing data of the address stored in the third memory into an unwritten part of the second areas.

10. A memory card comprising:
a memory including a plurality of first areas and a plurality of second areas, the first areas and the second areas being composed of a plurality of write unit areas; and
a computing section giving an instruction to write writing data with an address assigned by a host unit into the memory,
wherein the computing section, when receiving a request to write the writing data of an address unequal to an expected value which is continuous with the address of the data last written, gives an instruction to write the writing data into an unwritten part of the second areas, regardless of the address.

11. The memory card according to claim 10, wherein the computing section gives an instruction to write the writing data of the address unequal to the expected value into an unwritten part of the first area.

12. The memory card according to claim 10, wherein the computing section gives an instruction to copy a latest writing data of each of the addresses stored in one of the second areas into a new second area which is another one of the second areas.

13. The memory card according to claim 10, wherein the first areas and the second areas are data erase units of the memory.

14. The memory card according to claim 13, wherein the memory is a NAND flash memory.

15. The memory card according to claim 10, wherein a specific number of consecutive addresses form a group, and
the computing section, when the data of the addresses belonging to a same group are written in two of the first areas, gives an instruction to write the data written in an old first area, which is one of the two of the first areas, into a new first area, which is another one of the two of the first areas, and gives an instruction to erase the data in the old first area.
